(19) United States
(12) Patent Application Publication
(10) Pub. No.: US 2005/0222335 A1
(43) Pub. Date: Oct. 6, 2005

(54) Elastomeric blend for air barriers

(75) Inventors: Glenn Edward Jones, Topeka, KS (US); Alan Anthony Galuska, Glen Garner, NJ (US); Walter Harvey Waddell, Pasadena, TX (US)

Correspondence Address: EXXONMOBIL CHEMICAL COMPANY, 5200 BAYWAY DRIVE, P.O. BOX 2149, BAYTOWN, TX, 77522-2149, US

(73) Assignee: ExxonMobil Chemical Paens Inc., Texas (US)

(21) Appl. No.: 10/518,886

(22) PCT Filed: May 30, 2003
(86) PCT No.: PCT/US03/16947

§ 371 Date: Dec. 21, 2004

Related U.S. Application Data
(60) Provisional application No. 60/396,497, filed on Jul. 17, 2002.

(51) Int. Cl. C08F 8/00

(52) U.S. Cl. 525/191

(57) ABSTRACT

The present invention provides a composition suitable for an air barrier such as an automotive tire innertube, innerliner, and aircraft tire innertube or innerliner, curing bladders, and other pneumatic devices. The composition comprises an elastomer comprising C₄ to C₇ isoolefin derived units; and a plastomer, wherein the plastomer is a copolymer of ethylene derived units and C₃ to C₁₀ α-olefin derived units, the plastomer having a density of less than 0.915 g/cm³. In a desirable embodiment, naphthenic and aromatic oils are substantially absent from the composition. In another embodiment, a polybutene processing oil is present. Further, in yet another embodiment, a secondary rubber is also present such as, for example, natural rubber or butyl rubber, or a butadiene-based rubber.

### CROSS REFERENCE TO RELATED APPLICATIONS

This application claims the benefit of Provisional Application No. 60/396,497, filed Jul. 17, 2002, the disclosure of which is incorporated by reference in its entirety.

### FIELD OF THE INVENTION

The present invention relates to blends of C₄ to C₇ isoolefin based polymers with semi-crystalline ethylene copolymers, or plastomers, for use in air barriers, with polybutene processing oil used as an additive in one aspect of the composition.

### BACKGROUND OF THE INVENTION

Halobutyl rubbers, which are isobutylene-based copolymers of C₄ to C₇ isoolefins and a multiolefins, are the polymers of choice for best air-retention in tires for passenger, truck, bus and aircraft vehicles. Bromobutyl rubber, chlorobutyl rubber, and halogenated star-branched butyl rubbers can be formulated for these specific applications. The selection of ingredients and additives for the final commercial formulation depends upon the balance of properties desired. Namely, processing properties of the green (uncured) compound in the tire plant versus the in-service performance of the cured tire composite, as well as the nature of the tire.

Polyethylene copolymers have been disclosed as possible additives in compositions with isobutylene-based rubbers, such as disclosed by Tsou et al. (WO 01/85837) and Dias et al. (WO 02/48257). While Tsou et al. demonstrate an improved green strength in certain compositions which include the semi-crystalline polyethylene copolymer EXACT and naphthenic/aromatic processing oils, the same composition demonstrated a higher air permeability, which is a disadvantage for air barrier applications. The inventors of the present invention have found, surprisingly, that the addition of semi-crystalline polyethylene copolymers, also known as “plastomers”, to certain compositions can improve the air permeation qualities, thus making the compositions more useful as an air barrier.

Further, while it is known that the addition of plasticizers such as aromatic-containing processing oils will increase the air permeability of polymers, (see, e.g., POLYMER PERMEABILITY 61-62 (J. Comyn ed., Elsevier Applied Science 1986); U.S. Pat. No. 4,279,284 (water vapor permeability); and U.S. Pat. No. 6,326,433 B1 (air permeability)), the inventors of the presently disclosed air barrier compositions have surprisingly found that polybutene processing oils can be used in certain formulations described herein to improve air barrier qualities by decreasing the air permeability, while maintaining other desirable properties of the compositions. Thus, the present invention is directed towards such improvements.

Other background references include U.S. Pat. No. 5,157,081 A, WO 02/32992, and EP 0 992 538 A.

### SUMMARY OF THE INVENTION

In one aspect, the present invention provides a composition suitable for an air barrier such as an automotive tire innertube, innerliner, and aircraft tire innertube or innerliner, curing bladders, and other pneumatic devices. The composition comprises an elastomer comprising C₄ to C₇ isoolefin derived units; and a plastomer, wherein the plastomer is a copolymer of ethylene derived units and C₃ to C₁₀ α-olefin derived units, the plastomer having a density of less than 0.915 g/cm³. In a desirable embodiment, naphthenic and aromatic oils are substantially absent from the composition. In another embodiment, a polybutene processing oil is present. Further, in yet another embodiment, a secondary rubber is also present such as, for example, natural rubber or butyl rubber, or a butadiene-based rubber.

### DETAILED DESCRIPTION OF THE INVENTION

The term “phr” is parts per hundred rubber, and is a measure common in the art wherein components of a composition are measured relative to a major elastomer component, based upon 100 parts by weight of the elastomer or elastomers.

As used herein, in reference to Periodic Table “Groups”, the new numbering scheme for the Periodic Table Groups are used as in HAWLEY'S CONDENSED CHEMICAL DICTIONARY 852 (13th ed. 1997).

The term “elastomer”, as used herein, refers to any polymer or composition of polymers consistent with the ASTM D1566 definition. The term “elastomer” may be used interchangeably with the term “rubber”, as used herein.

As used herein, the term “alkyl” refers to a paraffinic hydrocarbon group which may be derived from an alkane by dropping one or more hydrogens from the formula, such as, for example, a methyl group, or CH₃, or an ethyl group, CH₃CH₂, etc.

As used herein, the term “alkenyl” refers to an unsaturated paraffinic hydrocarbon group which may be derived from an alkane by dropping one or more hydrogens from the formula, such as, for example, an ethenyl group, CH₂═CH, and a propenyl group, or CH₃CH═CH, etc.

As used herein, the term “aryl” refers to a hydrocarbon group that forms a ring structure characteristic of aromatic compounds such as, for example, benzene, naphthalene, phenanthrene, anthracene, etc., and typically possess alternate double bonding (“unsaturation”) within its structure. An aryl group is thus a group derived from an aromatic compound by dropping one or more hydrogens from the formula such as, for example, phenyl, or C₆H₅.

By “substituted”, it is meant substitution of at least one hydrogen group by at least one substituent selected from, for example, halogen (chlorine, bromine, fluorine, or iodine), amino, nitro, sulfoxy (sulfonate or alkyl sulfonate), thiol, alkylthiol, and hydroxy; alkyl, straight or branched chain having 1 to 20 carbon atoms which includes methyl, ethyl, propyl, tert-butyl, isopropyl, isobutyl, etc.; alkoxy, straight or branched chain alkoxy having 1 to 20 carbon atoms, and includes, for example, methoxy, ethoxy, propoxy, isopropoxy, butoxy, isobutoxy, secondary butoxy, tertiary butoxy, pentyloxy, isopentyloxy, hexyloxy, heptryloxy, octyloxy, nonyloxy, and decyloxy; haloalkyl, which means straight or branched chain alkyl having 1 to 20 carbon atoms which is substituted by at least one halogen, and includes, for example, chloromethyl, bromomethyl, fluoromethyl, iodomethyl, 2-chloroethyl, 2-bromoethyl, 2-fluoroethyl, 3-chloropropyl, 3-bromopropyl, 3-fluoropropyl, 4-chlorobutyl, 4-fluorobutyl, dichloromethyl, dibromomethyl, difluoromethyl, diiodomethyl, 2,2-dichloroethyl, 2,2-dibromomethyl, 2,2-difluoroethyl, 3,3-dichloropropyl, 3,3-difluoropropyl, 4,4-dichlorobutyl, 4,4-difluorobutyl, trichloromethyl, 4,4-difluorobutyl, trichloromethyl, trifluoromethyl, 2,2,2-trifluoroethyl, 2,3,3-trifluoropropyl, 1,1,2,2-tetrafluoroethyl, and 2,2,3,3-tetrafluoropropyl. Thus, for example, a “substituted styrenic unit” includes p-methylstyrene, p-ethylstyrene, etc.

Elastomer

Compositions of the present invention include at least one elastomer. The elastomer in one embodiment of the invention comprises C₄ to C₇ isoolefin derived units. These polymers can be described as homopolymers or random copolymers of C₄ to C₇ isoolefin derived units. In one embodiment, the C₄ to C₇ isoolefin derived units are selected from isobutylene, isobutene, 2-methyl-1-butene, 3-methyl-1-butene, 2-methyl-2-butene, 1-butene, 2-butene, methyl vinyl ether, indene, vinyltrimethylsilane, hexene, and 4-methyl-1-pentene. Further, the elastomer may also comprise multiolefin derived units selected from isoprene, butadiene, 2,3-dimethyl-1,3-butadiene, myrcene, 6,6-dimethyl-fulvene, hexadiene, cyclopentadiene, and piperylene. In yet another embodiment, the elastomer also comprises styrenic derived units selected from styrene and substituted styrenes, non-limiting examples of which include chlorostyrene, methoxystyrene, indene and indene derivatives, α-methylstyrene, o-methylstyrene, m-methylstyrene, and p-methylstyrene, and p-tert-butylstyrene. In yet a further embodiment of the invention, the elastomer is halogenated.

In one embodiment of the invention, the elastomer is a butyl-type rubber or branched butyl-type rubber, especially halogenated versions of these elastomers. Useful elastomers are unsaturated butyl rubbers such as homopolymers and copolymers of olefins or isoolefins and multiolefins, or homopolymers of multiolefins. These and other types of elastomers suitable for the invention are well known and are described in RUBBER TECHNOLOGY 209-581 (Maurice Morton ed., Chapman & Hall 1995), THE VANDERBILT RUBBER HANDBOOK 105-122 (Robert F. Ohm ed., R.T. Vanderbilt Co., Inc. 1990), and Edward Kresge and H. C. Wang in 8 KIRK-OTHMER ENCYCLOPEDIA OF CHEMICAL TECHNOLOGY 934-955 (John Wiley & Sons, Inc. 4th ed. 1993). Non-limiting examples of unsaturated elastomers useful in the method and composition of the present invention are poly(isobutylene-co-isoprene), polyisoprene, polybutadiene, polyisobutylene, poly(styrene-co-butadiene), natural rubber, star-branched butyl rubber, and mixtures thereof. Useful elastomers in the present invention can be made by any suitable means known in the art, and the invention is not herein limited by the method of producing the elastomer.

Butyl rubbers are prepared by reacting a mixture of monomers, the mixture having at least (1) a C₄ to C₇ isoolefin monomer component such as isobutylene with (2) a multiolefin, monomer component. The isoolefin is in a range from 70 to 99.5 wt % by weight of the total monomer mixture in one embodiment, and 85 to 99.5 wt % in another embodiment. The multiolefin component is present in the monomer mixture from 30 to 0.5 wt % in one embodiment, and from 15 to 0.5 wt % in another embodiment. In yet another embodiment, from 8 to 0.5 wt % of the monomer mixture is multiolefin.

The isoolefin is a C₄ to C₇ compound, non-limiting examples of which are compounds such as isobutylene, isobutylene, 2-methyl-1-butene, 3-methyl-1-butene. 2-methyl-2-butene, 1-butene, 2-butene, methyl vinyl ether, indene, vinyltrimethylsilane, hexene, and 4-methyl-1-pentene. The multiolefin is a C₄ to C₁₄ multiolefin such as isoprene, butadiene, 2,3-dimethyl-1,3-butadiene, myrcene, 6,6-dimethyl-fulvene, hexadiene, cyclopentadiene, and piperylene, and other monomers such as disclosed in EP 0 279 456 and U.S. Pat. Nos. 5,506,316 and 5,162,425. Other polymerizable monomers such as styrene and dichlorostyrene are also suitable for homopolymerization or copolymerization in butyl rubbers. One embodiment of the butyl rubber polymer of the invention is obtained by reacting 95 to 99.5 wt % of isobutylene with 0.5 to 8 wt % isoprene, or from 0.5 wt % to 5.0 wt % isoprene in yet another embodiment. Butyl rubbers and methods of their production are described in detail in, for example, U.S. Pat. Nos. 2,356,128, 3,968,076, 4,474,924, 4,068,051 and 5,532,312.

A commercial example of a desirable butyl rubber is EXXON™ BUTYL Grades of poly(isobutylene-co-isoprene), having a Mooney viscosity of from 32±2 to 51±5 (ML 1+8 at 125° C.). Another commercial example of a desirable butyl-type rubber is VISTANEX™ polyisobutylene rubber having a molecular weight viscosity average of from 0.9±0.15×10⁶ to 2.11±0.23×10⁶.

Another embodiment of the butyl rubber useful in the invention is a branched or “star-branched” butyl rubber. These rubbers are described in, for example, EP 0 678 529 B1, U.S. Pat. Nos. 5,182,333 and 5,071,913. In one embodiment, the star-branched butyl rubber (“SBB”) is a composition of a butyl rubber, either halogenated or not, and a polydiene or block copolymer, either halogenated or not. The invention is not limited by the method of forming the SBB. The polydienes/block copolymer, or branching agents (hereinafter “polydienes”), are typically cationically reactive and are present during the polymerization of the butyl or halogenated butyl rubber, or can be blended with the butyl rubber to form the SBB. The branching agent or polydiene can be any suitable branching agent, and the invention is not limited to the type of polydiene used to make the SBB.

In one embodiment, the SBB is typically a composition of the butyl or halogenated butyl rubber as described above and a copolymer of a polydiene and a partially hydrogenated polydiene selected from the group including styrene, polybutadiene, polyisoprene, polypiperylene, natural rubber, styrene-butadiene rubber, ethylene-propylene diene rubber (EPDM), ethylene-propylene rubber (EPR), styrene-butadiene-styrene and styrene-isoprene-styrene block copolymers. These polydienes are present, based on the monomer wt %, greater than 0.3 wt % in one embodiment, and from 0.3 to 3 wt % in another embodiment, and from 0.4 to 2.7 wt % in yet another embodiment.

A commercial embodiment of the SBB of the present invention is SB Butyl 4266 (ExxonMobil Chemical Company, Houston Tex.), having a Mooney viscosity (ML 1+8 at 125° C., ASTM D 1646) of from 34 to 44. Further, cure characteristics of SB Butyl 4266 are as follows: MH is 69±6 dN·m, ML is 11.5±4.5 dN·m (ASTM D2084).

The elastomer in a desirable embodiment of the invention is halogenated. Halogenated butyl rubber is produced by the halogenation of the butyl rubber product described above. Halogenation can be carried out by any means, and the invention is not herein limited by the halogenation process. Methods of halogenating polymers such as butyl polymers are disclosed in U.S. Pat. Nos. 2,631,984, 3,099,644, 4,554,326, 4,681,921, 4,650,831, 4,384,072, 4,513,116 and 5,681,901. In one embodiment, the butyl rubber is halogenated in hexane diluent at from 4 to 60° C. using bromine (Br₂) or chlorine (Cl₂) as the halogenation agent. The halogenated butyl rubber has a Mooney Viscosity of from 20 to 70 (ML 1+8 at 125° C.) in one embodiment, and from 25 to 55 in another embodiment. The halogen wt % is from 0.1 to 10 wt % based in on the weight of the halogenated butyl rubber in one embodiment, and from 0.5 to 5 wt % in another embodiment. In yet another embodiment, the halogen wt % of the halogenated butyl rubber is from 1 to 2.5 wt %.

A commercial embodiment of a suitable halogenated butyl rubber of the present invention is Bromobutyl 2222 (ExxonMobil Chemical Company). Its Mooney Viscosity is from 27 to 37 (ML 1+8 at 125° C. ASTM 1646, modified), and the bromine content is from 1.8 to 2.2 wt % relative to the Bromobutyl 2222. Further, cure characteristics of Bromobutyl 2222 are as follows: MH is from 28 to 40 dN·m, ML is from 7 to 18 dN·m (ASTM D 2084). Another commercial embodiment of the halogenated butyl rubber is Bromobutyl 2255 (ExxonMobil Chemical Company). Its Mooney Viscosity is from 41 to 51 (ML 1+8 at 125° C., ASTM D 1646), and the bromine content is from 1.8 to 2.2 wt %. Further, cure characteristics of Bromobutyl 2255 are as follows: MH is from 34 to 48 dN·m, ML is from 11 to 21 dN·m (ASTM D 2084).

In another embodiment of elastomer of the invention, a branched or “star-branched” halogenated butyl rubber is used. In one embodiment, the halogenated star-branched butyl rubber is a composition of a butyl rubber, either halogenated or not, and a polydiene or block copolymer, either halogenated or not. The halogenation process is described in detail in U.S. Pat. Nos. 4,074,035, 5,071,913, 5,286,804, 5,182,333 and 6,228,978. The invention is not limited by the method of forming the halogenated star branched butyl rubber. The polydienes/block copolymer, or branching agents (hereinafter “polydienes”), are typically cationically reactive and are present during the polymerization of the butyl or halogenated butyl rubber, or can be blended with the butyl or halogenated butyl rubber to form the halogenated star branched butyl rubber. The branching agent or polydiene can be any suitable branching agent, and the invention is not limited to the type of polydiene used to make the halogenated star branched butyl rubber.

In one embodiment, the halogenated star branched butyl rubber is typically a composition of the butyl or halogenated butyl rubber as described above and a copolymer of a polydiene and a partially hydrogenated polydiene selected from the group including styrene, polybutadiene, polyisoprene, polypiperylene, natural rubber, styrene-butadiene rubber, ethylene-propylene diene rubber, styrene-butadiene-styrene and styrene-isoprene-styrene block copolymers. These polydienes are present, based on the monomer wt %, greater than 0.3 wt % in one embodiment, and from 0.3 to 3 wt % in another embodiment, and from 0.4 to 2.7 wt % in yet another embodiment.

A commercial embodiment of the halogenated star branched butyl rubber of the present invention is Bromobutyl 6222 (ExxonMobil Chemical Company), having a Mooney Viscosity (ML 1+8 at 125° C., ASTM D1646) of from 27 to 37, and a bromine content of from 2.2 to 2.6 wt % relative to the halogenated star branched butyl rubber. Further, cure characteristics of Bromobutyl 6222 are as follows: MH is from 24 to 38 dN·m, ML is from 6 to 16 dN·m (ASTM D2084).

Another embodiment of the isobutylene-based elastomer useful in present invention comprises styrenic derived units. The elastomer in one embodiment of the invention is a random copolymer comprising C₄ to C₇ isoolefin derived units, such as isobutylene derived units, and styrenic units selected from styrene and substituted styrenes such as, for example, chlorostyrene, methoxystyrene, indene and indene derivatives, α-methylstyrene, o-methylstyrene, m-methylstyrene, and p-methylstyrene, p-halomethylstyrene (also including ortho and meta-halomethylstyrene) and p-tert-butylstyrene. In one embodiment, the halomethylstyrene derived unit is a p-halomethylstyrene containing at least 80%, more preferably at least 90% by weight of the para-isomer. The “halo” group can be any halogen, desirably chlorine or bromine. The halogenated elastomer may also include functionalized interpolymers wherein at least some of the alkyl substituents groups present in the styrene monomer units contain benzylic halogen or some other functional group described further below.

Preferred materials may be characterized as terpolymers containing C₄ to C₇ isoolefin derived units and the following monomer units randomly spaced along the polymer chain: 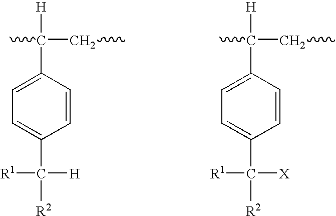
wherein R¹ and R² are independently hydrogen, lower alkyl, preferably C₁ to C₇ alkyl and primary or secondary alkyl halides and X is a functional group such as halogen. Preferably R¹ and R² are each hydrogen. Up to 60 mol % of the para-substituted styrene present in the elastomer structure may be the functionalized structure above in one embodiment, and in another embodiment from 0.1 to 5 mol %.

The functional group X may be halogen or a combination of a halogen and some other functional group such which may be incorporated by nucleophilic substitution of benzylic halogen with other groups such as carboxylic acids; carboxy salts; carboxy esters, amides and imides; hydroxy; alkoxide; phenoxide; thiolate; thioether; xanthate; cyanide; nitrile; amino and mixtures thereof. These functionalized isoolefin copolymers, their method of preparation, methods of functionalization, and cure are more particularly disclosed in U.S. Pat. No. 5,162,445, and in particular, the functionalized amines as described above.

An example of a suitable elastomer for use in the present invention is poly(isobutylene-co-p-methylstyrene), or “XP50” (ExxonMobil Chemical Company, Houston Tex.). Another useful elastomer is a terpolymer of isobutylene and p-methylstyrene containing from 0.5 to 20 mol % p-methylstyrene, wherein up to 60 mol % of the methyl substituent groups present on the benzyl ring contain a bromine or chlorine atom, preferably a bromine atom (p-bromomethylstyrene), as well as a combination of p-bromomethylstyrene and other functional groups such as ester and ether. These halogenated elasiomers are commercially available as EXXPRO™ Elastomers (ExxonMobil Chemical Company, Houston Tex.), and abbreviated as “BIMS”. These isoolefin copolymers, their method of preparation and cure are more particularly disclosed in U.S. Pat. No. 5,162,445. These elastomers have a substantially homogeneous compositional distribution such that at least 95% by weight of the polymer has a p-alkylstyrene content within 10% of the average p-alkylstyrene content of the polymer. Desirable copolymers are also characterized by a molecular weight distribution (Mw/Mn) of between 2 and 20 in one embodiment, and less than 10 in another embodiment, and less than 5 in another embodiment, and less than 2.5 in yet another embodiment, and greater than 2 in yet another embodiment; a preferred viscosity average molecular weight in the range of from 200,000 up to 2,000,000 and a preferred number average molecular weight in the range of from 25,000 to 750,000 as determined by gel permeation chromatography.

The “elastomer”, as described herein, may also comprise a composition of one or more of the same elastomer having differing molecular weights to yield a composition having a bimodal molecular weight distribution. This bimodal distribution can be achieved by, for example, having a low molecular weight component in the elastomer. This can be accomplished by physically blending two different MW polymers together, or by in situ reactor blending. In one embodiment, the elastomer has a low molecular weight (weight average molecular weight) component of from 5,000 MW to 80,000 MW in one embodiment, and from 10,000 MW to 60,000 MW in another embodiment; the low molecular weight component comprising from 5 to 40 wt % of the composition in one embodiment, and from 10 to 30 wt % of the composition in another embodiment.

In a preferred embodiment, the functionality is selected such that it can react or form polar bonds with functional groups present in the matrix polymer, for example, acid, amino or hydroxyl functional groups, when the polymer components are mixed at high temperatures.

The XP50 and BIMS polymers may be prepared by a slurry polymerization of the monomer mixture using a Lewis acid catalyst, followed by halogenation, preferably bromination, in solution in the presence of halogen and a radical initiator such as heat and/or light and/or a chemical initiator and, optionally, followed by electrophilic substitution of bromine with a different functional moiety.

Preferred BIMS polymers are brominated polymers that generally contain from 0.1 to 5 mole % of bromomethylstyrene groups relative to the total amount of monomer derived units in the polymer. In another embodiment, the amount of bromomethyl groups is from 0.2 to 3.0 mol %, and from 0.3 to 2.8 mol % in yet another embodiment, and from 0.4 to 2.5 mol % in yet another embodiment, and from 0.3 to 2.0 in yet another embodiment, wherein a desirable range may be any combination of any upper limit with any lower limit. Expressed another way, preferred copolymers contain from 0.2 to 10 wt % of bromine, based on the weight of the polymer, from 0.4 to 6 wt % bromine in another embodiment, and from 0.6 to 5.6 wt % in another embodiment, are substantially free of ring halogen or halogen in the polymer backbone chain. In one embodiment of the invention, the elastomer is a copolymer of C₄ to C₇ isoolefin derived units (or isomonoolefin), p-methylstyrene derived units and p-halomethylstyrene derived units, wherein the p-halomethylstyrene units are present in the interpolymer from 0.4 to 3.0 mol % based on the total number of p-methylstyrene, and wherein the para-methylstyrene derived units are present from 3 wt % to 15 wt % based on the total weight of the polymer in one embodiment, and from 4 wt % to 10 wt % in another embodiment. In another embodiment, the p-halomethylstyrene is p-bromomethylstyrene.

The elastomer may be present in compositions of the invention from 10 to 100 phr in one embodiment, and from 20 to 80 phr in another embodiment, and from 30 to 70 phr in yet another embodiment, and from 40 to 60 phr in yet another embodiment, wherein a desirable phr range for the elastomer is any upper phr limit combined with any lower phr limit described herein.

Plastomer

The plastomers that are useful in the present invention can be described as polyolefin copolymers having a density of from 0.85 to 0.915 g/cm³ and a melt index (MI) between 0.10 and 30 dg/min. In one embodiment, the useful plastomer is a copolymer of ethylene derived units and at least one of C₃ to C₁₀ α-olefin derived units, the copolymer having a density in the range of less than 0.915 g/cm³. The amount of comonomer (C₃ to C₁₀ α-olefin derived units) present in the plastomer ranges from 2 wt % to 35 wt % in one embodiment, and from 5 wt % to 30 wt % in another embodiment, and from 15 wt % to 25 wt % in yet another embodiment, and from 20 wt % to 30 wt % in yet another embodiment.

The plastomer useful in the invention has a melt index (MI) of between 0.10 and 20 dg/min (ASTM D 1238; 190° C., 2.1 kg) in one embodiment, and from 0.2 to 10 dg/min in another embodiment, and from 0.3 to 8 dg/min in yet another embodiment. The average molecular weight of useful plastomers ranges from 10,000 to 800.000 in one embodiment, and from 20,000 to 700,000 in another embodiment. The 1% secant flexural modulus (ASTM D 790) of useful plastomers ranges from 10 MPa to 150 MPa in one embodiment, and from 20 MPa to 100 MPa in another embodiment. Further, the plastomer that is useful in compositions of the present invention has a melting temperature (Tm) of from 50 to 62° C. (first melt peak) and from 65 to 85° C. (second melt peak) in one embodiment, and from 52 to 60° C. (first melt peak) and from 70 to 80° C. (second melt peak) in another embodiment.

Plastomers useful in the present invention are metallocene catalyzed copolymers of ethylene derived units and higher α-olefin derived units such as propylene, 1-butene, 1-hexene and 1-octene, and which contain enough of one or more of these comonomer units to yield a density between 0.860 and 0.900 g/cm³ in one embodiment. The molecular weight distribution (Mw/Mn) of desirable plastomers ranges from 2 to 5 in one embodiment, and from 2.2 to 4 in another embodiment. Examples of a commercially available plastomers are EXACT 4150, a copolymer of ethylene and 1-hexene, the 1-hexene derived units making up from 18 to 22 wt% of the plastomer and having a density of 0.895 g/cm³ and MI of 3.5 dg/min (ExxonMobil Chemical Company; Houston, Tex.); and EXACT 8201, a copolymer of ethylene and 1-octene, the 1-octene derived units making up from 26 to 30 wt % of the plastomer, and having a density of 0.882 g/cm³ and MI of 1.0 dg/min (ExxonMobil Chemical Company, Houston, Tex.).

Polybutene Processing Oil

In one aspect of the invention, a polybutene processing oil may be present in air barrier compositions. In one embodiment of the invention, the polybutene processing oil is a low molecular weight (less than 15,000 Mn) homopolymer or copolymer of olefin derived units having from 3 to 8 carbon atoms in one embodiment, preferably from 4 to 6 carbon atoms in another embodiment. In yet another embodiment, the polybutene is a homopolymer or copolymer of a C₄ raffinate. An embodiment of such low molecular weight polymers termed “polybutene” polymers is described in, for example, SYNTHETIC LUBRICANTS AND HIGH-PERFORMANCE FUNCTIONAL FLUIDS 357-392 (Leslie R. Rudnick & Ronald L. Shubkin, ed., Marcel Dekker 1999) (hereinafter “polybutene processing oil” or “polybutene”).

In one embodiment of the invention, the polybutene processing oil is a copolymer of at least isobutylene derived units, 1-butene derived units, and 2-butene derived units. In one embodiment, the polybutene is a homopolymer, copolymer, or terpolymer of the three units, wherein the isobutylene derived units are from 40 to 100 wt % of the copolymer, the 1-butene derived units are from 0 to 40 wt % of the copolymer, and the 2-butene derived units are from 0 to 40 wt % of the copolymer. In another embodiment, the polybutene is a copolymer or terpolymer of the three units, wherein the isobutylene derived units are from 40 to 99 wt % of the copolymer, the 1-butene derived units are from 2 to 40 wt % of the copolymer, and the 2-butene derived units are from 0 to 30 wt % of the copolymer. In yet another embodiment, the polybutene is a terpolymer of the three units, wherein the isobutylene derived units are from 40 to 96 wt % of the copolymer, the 1-butene derived units are from 2 to 40% % of the copolymer, and the 2-butene derived units are from 2 to 20 wt % of the copolymer. In yet another embodiment, the polybutene is a homopolymer or copolymer of isobutylene and 1-butene, wherein the isobutylene derived units are from 65 to 100 wt % of the homopolymer or copolymer, and the 1-butene derived units are from 0 to 35 wt % of the copolymer.

Polybutene processing oils useful in the invention typically have a number average molecular weight (Mn) of less than 10,000 in one embodiment, less than 8000 in another embodiment, and less than 6000 in yet another embodiment. In one embodiment, the polybutene oil has a number average molecular weight of greater than 400, and greater than 700 in another embodiment, and greater than 900 in yet another embodiment. A preferred embodiment can be a combination of any lower molecular weight limit with any upper molecular weight limit herein. For example, in one embodiment of the polybutene of the invention, the polybutene has a number average molecular weight of from 400 to 10,000, and from 700 to 8000 in another embodiment, and from 900 to 3000 in yet another embodiment. Useful viscosities of the polybutene processing oil ranges from 10 to 6000 cSt (centiStokes) at 100° C. in one embodiment, and from 35 to 5000 cSt at 100° C. in another embodiment, and is greater than 35 cSt at 100° C. in yet another embodiment, and greater than 100 cSt at 100° C. in yet another embodiment.

Commercial examples of such a processing oil are the PARAPOL™ Series of processing oils (ExxonMobil Chemical Company, Houston Tex.), such as PARAPOL™ 450, 700, 950, 1300, 2400 and 2500. The commercially available PARAPOL™ Series of polybutene processing oils are synthetic liquid polybutenes, each individual formulation having a certain molecular weight, all formulations of which can be used in the composition of the invention. The molecular weights of the PARAPOL™ oils are from 420 Mn (PARAPOL™ 450) to 2700 Mn (PARAPOL™ 2500) as determined by gel permeation chromatography. The MWD of the PARAPOL™ oils range from 1.8 to 3 in one embodiment, and from 2 to 2.8 in another embodiment.

Below, Table 1 shows some of the properties of the PARAPOL™ oils useful in embodiments of the present invention, wherein the viscosity was determined as per ASTM D445-97, and the molecular weight by gel permeation chromatography.

TABLE 1
Properties of individual PARAPOL ™ Grades

| | | Viscosity @ |
|---|---|---|
| Grade | Mn | 100° C., cSt |
| 450 | 420 | 10.6 |
| 700 | 700 | 78 |
| 950 | 950 | 230 |
| 1300 | 1300 | 630 |
| 2400 | 2350 | 3200 |
| 2500 | 2700 | 4400 |

Other properties of PARAPOL™ processing oils are as follows: the density (g/mL) of PARAPOL™ processing oils varies from about 0.85 (PARAPOL™ 450) to 0.91 (PARAPOL™ 2500). The bromine number (CG/G) for PARAPOL™ oils ranges from 40 for the 450 Mn processing oil, to 8 for the 2700 Mn processing oil.

The elastomeric composition of the invention may include one or more types of polybutene as a mixture, blended either prior to addition to the elastomer, or with the elastomer. The amount and identity (e.g., viscosity, Mn, etc.) of the polybutene processing oil mixture can be varied in this manner. Thus, PARAPOL™ 450 can be used when low viscosity is desired in the composition of the invention, while PARAPOL™ 2500 can be used when a higher viscosity is desired, or compositions thereof to achieve some other viscosity or molecular weight. In this manner, the physical properties of the composition can be controlled. More particularly, the phrases “polybutene processing oil”, or “polybutene processing oil” include a single oil or a composition of two or more oils used to obtain any viscosity or molecular weight (or other property) desired, as specified in the ranges disclosed herein.

The polybutene processing oil or oils are present in the elastomeric composition of the invention from 1 to 60 phr in one embodiment, and from 2 to 40 phr in another embodiment, from 4 to 35 phr in another embodiment, and from 5 to 30 phr in yet another embodiment, and from 2 to 10 phr in yet another embodiment, and from 5 to 25 phr in yet another embodiment, and from 2 to 20 phr in yet another embodiment, wherein a desirable range of polybutene may be any upper phr limit combined with any lower phr limit described herein. Preferably, the polybutene processing oil does not contain aromatic groups or unsaturation.

Secondary Rubber Component

A secondary rubber, or “general purpose rubber” component may be present in compositions and end use articles of the present invention. These rubbers may be blended by any suitable means with the elastomer or elastomer composition. These rubbers include, but are not limited to, natural rubbers, polyisoprene rubber, poly(styrene-co-butadiene) rubber (SBR), polybutadiene rubber (BR), poly(isoprene-co-butadiene) rubber (IBR), styrene-isoprene-butadiene rubber (SIBR), ethylene-propylene rubber (EPR), ethylene-propylene-diene rubber (EPDM), polysulfide, nitrile rubber, propylene oxide polymers, star-branched butyl rubber and halogenated star-branched butyl rubber, brominated butyl rubber, chlorinated butyl rubber, star-branched polyisobutylene rubber, star-branched brominated butyl (polyisobutylene/isoprene copolymer) rubber; poly(isobutylene-co-p-methylstyrene) and halogenated poly(isobutylene-co-p-methylstyrene), such as, for example, terpolymers of isobutylene derived units, p-methylstyrene derived units, and p-bromomethylstyrene derived units, and mixtures thereof.

A desirable embodiment of the secondary rubber component present is natural rubber. Natural rubbers are described in detail by Subramaniam in RUBBER TECHNOLOGY 179-208 (Maurice Morton, ed., Chapman & Hall 1995). Desirable embodiments of the natural rubbers of the present invention are selected from Malaysian rubber such as SMR CV, SMR 5, SMR 10, SMR 20, and SMR 50 and mixtures thereof, wherein the natural rubbers have a Mooney viscosity at 100° C. (ML 1+4) of from 30 to 120, more preferably from 40 to 65. The Mooney viscosity test referred to herein is in accordance with ASTM D-1646. In a desirable embodiment of the invention, natural rubber is present in the composition from 5 to 25 phr.

Polybutadiene (BR) rubber is another desirable secondary rubber useful in the composition of the invention. The Mooney viscosity of the polybutadiene rubber as measured at 100° C. (ML 1+4) may range from 35 to 70, from 40 to about 65 in another embodiment, and from 45 to 60 in yet another embodiment. Some commercial examples of these synthetic rubbers useful in the present invention are NATSYN™ (Goodyear Chemical Company), and BUDENE™ 1207 or BR 1207 (Goodyear Chemical Company). A desirable rubber is high cis-polybutadiene (cis-BR). By “cis-polybutadiene” or “high cis-polybutadiene”, it is meant that 1,4-cis polybutadiene is used, wherein the amount of cis component is at least 95%. An example of high cis-polybutadiene commercial products used in the composition BUDENE™ 1207.

Rubbers of ethylene and propylene derived units such as EPR and EPDM are also suitable as secondary rubbers. Examples of suitable comonomers in making EPDM are ethylidene norbornene, 1,4-hexadiene, dicyclopentadiene, as well as others. These rubbers are described in RUBBER TECHNOLOGY 260-283 (1995). A suitable ethylene-propylene rubber is commercially available as VISTALON™ (ExxonMobil Chemical Company, Houston Tex.).

In another embodiment, the secondary rubber is a halogenated rubber as part of the terpolymer composition. The halogenated butyl rubber is brominated butyl rubber, and in another embodiment is chlorinated butyl rubber. General properties and processing of halogenated butyl rubbers are described in THE VANDERBILT RUBBER HNDBOOK 105-122 (Robert F. Ohm ed., R.T. Vanderbilt Co., Inc. 1990), and in RUBBER TECHNOLOGY 311-321 (1995). Butyl rubbers, halogenated butyl rubbers, and star-branched butyl rubbers are described by Edward Kresge and H. C. Wang in 8 KIRK-OTHMER ENCYCLOPEDIA OF CHEMICAL TECHNOLOGY 934-955 (John Wiley & Sons, Inc. 4th ed. 1993).

The secondary rubber component of the present invention includes, but is not limited to at least one or more of brominated butyl rubber, chlorinated butyl rubber, star-branched polyisobutylene rubber, star-branched brominated butyl (polyisobutylene/isoprene copolymer) rubber; halogenated poly(isobutylene-co-p-methylstyrene), such as, for example, terpolymers of isobutylene derived units, p-methylstyrene derived units, and p-bromomethylstyrene derived units (BrIBMS), and the like halomethylated aromatic interpolymers as in U.S. Pat. No. 5,162,445; U.S. Pat. No. 4,074,035; and U.S. Pat. No. 4,395,506; halogenated isoprene and halogenated isobutylene copolymers, polychloroprene, and the like, and mixtures of any of the above. Some embodiments of the halogenated rubber component are also described in U.S. Pat. No. 4,703,091 and U.S. Pat. No. 4,632,963.

The secondary rubber component of the elastomer composition may be present in a range from up to 90 phr in one embodiment, from up to 50 phr in another embodiment, from up to 40 phr in another embodiment, and from up to 30 phr in yet another embodiment. In yet another embodiment, the secondary rubber is present from at least 2 phr, and from at least 5 phr in another embodiment, and from at least 5 phr in yet another embodiment, and from at least 10 phr in yet another embodiment. A desirable embodiment may include any combination of any upper phr limit and any lower phr limit. For example, the secondary rubber, either individually or as a blend of rubbers such as, for example NR, may be present from 5 phr to 40 phr in one embodiment, and from 8 to 30 phr in another embodiment, and from 10 to 25 phr in yet another embodiment, and from 5 to 25 phr in yet another embodiment, and from 5 to 15 phr in yet another embodiment, wherein a desirable range of NR may be any combination of any upper phr limit with any lower phr limit.

The elastomeric composition may have one or more filler components such as, for example, calcium carbonate, silica, clay and other silicates which may or may not be exfoliated, talc, titanium dioxide, and carbon black. In one embodiment, the filler is carbon black or modified carbon black, and combinations of any of these. In another embodiment, the filler is a blend of carbon black and silica. The preferred filler for such articles as tire treads and sidewalls is reinforcing grade carbon black present at a level of from 10 to 100 phr of the blend, more preferably from 30 to 80 phr in another embodiment, and from 50 to 80 phr in yet another embodiment. Useful grades of carbon black, as described in RUBBER TECHNOLOGY, 59-85, range from N110-N990. More desirably, embodiments of the carbon black useful in, for example, tire treads are N229, N351, N339, N220, N234 and N110 provided in ASTM (D3037, D1510, and D3765). Embodiments of the carbon black useful in, for example, sidewalls in tires, are N330, N315, N550, N650, N660, and N762. Carbon blacks suitable for innerliners and other air barriers include N550, N660, N650, N762, N990 an Regal 85.

When clay is present as a filler, it may be a swellable clay in one embodiment, which may or may not be exfoliated using an exfoliating agent. Swellable clay materials suitable for the purposes of this invention include natural or synthetic phyllosilicates, particularly smectic clays such as montmorillonite, nontronite, beidellite, volkonskoite, laponite, hectorite, saponite, sauconite, magadite, kenyaite, stevensite and the like, as well as vermiculite, halloysite, aluminate oxides, hydrotalcite and the like. These swellable clays generally comprise particles containing a plurality of silicate platelets having a thickness of 8-12 Å, and contain exchangeable cations such as Na⁺, Ca⁺², K⁺ or Mg⁺² present at the interlayer surfaces.

The swellable clay may be exfoliated by treatment with organic molecules (swelling or exfoliating “agents” or “additives”) capable of undergoing ion exchange reactions with the cations present at the interlayer surfaces of the layered silicate. Suitable exfoliating agents include cationic surfactants such as ammonium, alkylamines or alkylammonium (primary, secondary, tertiary and quaternary), phosphonium or sulfonium derivatives of aliphatic, aromatic or arylaliphatic amines, phosphines and sulfides. Desirable amine compounds (or the corresponding ammonium ion) are those with the structure R²R³R⁴N, wherein R², R³, and R⁴ are C₁ to C₃₀ alkyls or alkenes in one embodiment, C₁ to C₂₀ alkyls or alkenes in another embodiment, which may be the same or different. In one embodiment, the exfoliating agent is a so called long chain tertiary amine, wherein at least R² is a C₁₄ to C₂₀ alkyl or alkene.

The fillers of the present invention may be any size and typically range, for example, from about 0.0001 μm to about 100 μm. As used herein, silica is meant to refer to any type or particle size silica or another silicic acid derivative, or silicic acid, processed by solution, pyrogenic or the like methods and having a surface area, including untreated, precipitated silica, crystalline silica, colloidal silica, aluminum or calcium silicates, fumed silica, and the like.

One or more crosslinking agents are preferably used in the elastomeric compositions of the present invention, especially when silica is the primary filler, or is present in combination with another filler. More preferably, the coupling agent may be a bifunctional organosilane crosslinking agent. An “organosilane crosslinking agent” is any silane coupled filler and/or crosslinking activator and/or silane reinforcing agent known to those skilled in the art including, but not limited to, vinyl triethoxysilane, vinyl-tris-(beta-methoxyethoxy)silane, methacryloylpropyltrimethoxysilane, gamma-amino-propyl triethoxysilane (sold commercially as A1100 by Witco), gamma-mercaptopropyltrimethoxysilane (A189 by Witco) and the like, and mixtures thereof. In one embodiment, bis-(3-triethoxysilypropyl)tetrasulfide (sold commercially as “Si69”) is employed.

A processing aid may also be present in the composition of the invention. Processing aids include, but are not limited to, plasticizers, tackifiers, extenders, chemical conditioners, homogenizing agents and peptizers such as mercaptans, petroleum and vulcanized vegetable oils, mineral oils, parraffinic oils, polybutene oils, naphthenic oils, aromatic oils, waxes, resins, rosins, and the like. The aid is typically present from 1 to 70 phr in one embodiment, from 3 to 60 phr in another embodiment, and from 5 to 50 phr in yet another embodiment. Some commercial examples of processing aids are SUNDEX™ (Sun Chemicals), a naphthenic processing oil, PARAPOL™ (ExxonMobil Chemical Company), a polybutene processing oil having a number average molecular weight of from 800 to 3000, and FLEXON™ (ExxonMobil Chemical Company), a paraffinic petroleum oil. In one embodiment of the invention, paraffinic, naphthenic and aromatic oils are substantially absent, meaning, they have not been deliberately added to the compositions used to make the air barriers, or, in the alternative, if present, are only present up to 0.2 wt % of the compositions used to make the air barriers. In another embodiment of compositions of the invention, naphthenic and aromatic oils are substantially absent. Commercial examples of these include, for example, FLEXON oils (which contain some aromatic moieties) and CALSOL oils (a naphthenic oil).

The compositions produced in accordance with the present invention typically contain other components and additives customarily used in rubber mixes, such as effective amounts of other nondiscolored and nondiscoloring processing aids, pigments, accelerators, crosslinking and curing materials, antioxidants, antiozonants. General classes of accelerators include amines, diamines, guanidines, thioureas, thiazoles, thiurams, sulfenamides, sulfenimides, thiocarbamates, xanthates, and the like. Crosslinking and curing agents include sulfur, zinc oxide, and fatty acids. Peroxide cure systems may also be used. The components, and other curatives, are typically present from 0.1 to 10 phr in the composition.

Generally, polymer blends, for example, those used to produce tires, are crosslinked. It is known that the physical properties, performance characteristics, and durability of vulcanized rubber compounds are directly related to the number (crosslink density) and type of crosslinks formed during the vulcanization reaction. (See, e.g., Helt et al., The Post Vulcanization Stabilization for NR in RUBBER WORLD, 18-23 (1991)). Generally, polymer blends may be crosslinked by adding curative molecules, for example sulfur, metal oxides, organometallic compounds, radical initiators, etc., followed by heating. In particular, the following metal oxides are common curatives that will function in the present invention: ZnO, CaO, MgO, Al₂O₃, CrO₃, FeO, Fe₂O₃, and NiO. These metal oxides can be used alone or in conjunction with the corresponding metal fatty acid complex (e.g., zinc stearate, calcium stearate, etc.), or with the organic and fatty acids added alone, such as stearic acid, and optionally other curatives such as sulfur or a sulfur compound, an alkylperoxide compound, diamines or derivatives thereof (e.g., DIAK products sold by DuPont). (See also, Formulation Design and Curing Characteristics of NBR Mixes for Seals, RUBBER WORLD 25-30 (1993)). This method of curing elastomers may be accelerated and is often used for the vulcanization of elastomer blends.

The acceleration of the cure process is accomplished in the present invention by adding to the composition an amount of an accelerant, often an organic compound. The mechanism for accelerated vulcanization of natural rubber involves complex interactions between the curative, accelerator, activators and polymers. Ideally, all of the available curative is consumed in the formation of effective crosslinks which join together two polymer chains and enhance the overall strength of the polymer matrix. Numerous accelerators are known in the art and include, but are not limited to, the following: stearic acid, diphenyl guanidine (DPG), tetramethylthiuram disulfide (TMTD), 4,4′-dithiodimorpholine (DTDM), tetrabutylthiuram disulfide (TBTD), benzothiazyl disulfide (MBTS), hexamethylene-1,6-bisthiosulfate disodium salt dihydrate (sold commercially as DURALINK™ HTS by Flex sys), 2-(morpholinothio)benzothiazole (MBS or MOR), blends of 90% MOR and 10% MBTS (MOR 90), N-tertiarybutyl-2-benzothiazole sulfenamide (TBBS), and N-oxydiethylene thiocarbamyl-N-oxydiethylene sulfonamide (OTOS), zinc 2-ethyl hexanoate (ZEH), and “thioureas”.

The materials included in the air barriers and air barrier compositions are mixed by conventional means known to those skilled in the art, in a single step or in stages. In one embodiment, the carbon black is added in a different stage from zinc oxide and other cure activators and accelerators. In another embodiment, antioxidants, antiozonants and processing materials are added in a stage after the carbon black has been processed with the elastomeric composition, and zinc oxide is added at a final stage to maximize compound modulus. Thus, a two to three (or more) stage processing sequence is preferred. Additional stages may involve incremental additions of filler and processing oils.

The compositions may be vulcanized by subjecting them using heat or radiation according to any conventional vulcanization process. Typically, the vulcanization is conducted at a temperature ranging from about 100° C. to about 250° C. in one embodiment, from 150° C. to 200° C. in another embodiment, for about 1 to 150 minutes.

Suitable elastomeric compositions for such articles as air barriers, and more particularly tire curing bladders, innerliners, tire innertubes, and air sleeves, including gaskets and ring structures, may be prepared by using conventional mixing techniques including, for example, kneading, roller milling, extruder mixing, internal mixing (such as with a Banbury™ or Brabender™ mixer) etc. The sequence of mixing and temperatures employed are well known to the skilled rubber compounder, the objective being the dispersion of fillers, activators and curatives in the polymer matrix without excessive heat buildup. A useful mixing procedure utilizes a Banbury™ mixer in which the copolymer rubber, carbon black and plasticizer are added and the composition mixed for the desired time or to a particular temperature to achieve adequate dispersion of the ingredients. Alternatively, the rubber and a portion of the carbon black (e.g., one-third to two thirds) is mixed for a short time (e.g., about 1 to 3 minutes) followed by the remainder of the carbon black and oil. Mixing is continued for about 1 to 10 minutes at high rotor speed during which time the mixed components reach a temperature of about 140° C. Following cooling, the components are mixed in a second step on a rubber mill or in a Banbury™ mixer during which the curing agent and optional accelerators, are thoroughly and uniformly dispersed at relatively low temperature, for example, about 80° C. to about 105° C., to avoid premature curing of the composition. Variations in mixing will be readily apparent to those skilled in the art and the present invention is not limited to any specific mixing procedure. The mixing is performed to disperse all components of the composition thoroughly and uniformly.

An innerliner stock is then prepared by calendering the compounded rubber composition into sheet material having a thickness of roughly 40 to 80 mil gauge and cutting the sheet material into strips of appropriate width and length for innerliner applications.

The sheet stock at this stage of the manufacturing process is a sticky, uncured mass and is therefore subject to deformation and tearing as a consequence of handling and cutting operations associated with tire construction.

The innerliner is then ready for use as an element in the construction of a pneumatic tire. The pneumatic tire is composed of a layered laminate comprising an outer surface which includes the tread and sidewall elements, an intermediate carcass layer which comprises a number of plies containing tire reinforcing fibers, (e.g., rayon, polyester, nylon or metal fibers) embedded in a rubbery matrix and an innerliner layer which is laminated to the inner surface of the carcass layer. Tires are normally built on a tire forming drum using the layers described above. After the uncured tire has been built on the drum, the uncured tire is placed in a heated mold having an inflatable tire shaping bladder to shape it and heat it to vulcanization temperatures by methods well known in the art. Vulcanization temperatures generally range from about 100° C. to about 250° C., more preferably from 125° C. to 200° C., and times may range from about one minute to several hours, more preferably from about 5 to 30 minutes. Vulcanization of the assembled tire results in vulcanization of all elements of the tire assembly, for example, the innerliner, the carcass and the outer tread/sidewall layers and enhances the adhesion between these elements, resulting in a cured, unitary tire from the multi-layers.

Thus, one aspect of the invention is a composition suitable for an air barrier comprising an elastomer comprising C₄ to C₇ isoolefin derived units; and a plastomer, wherein the plastomer is a copolymer of ethylene derived units and C₃ to C₁₀ α-olefin derived units, the plastomer having a density of less than 0.915 g/cm³. Further, naphthenic and aromatic oils are substantially absent from the composition in one embodiment.

In another embodiment, the plastomer comprises ethylene derived units and from 10 wt % to 30 wt % of C₃ to C₁₀ α-olefin derived units. In yet another embodiment, the plastomer comprises ethylene derived units and from 10 wt % to 30 wt % of units selected from 1-butene, 1-hexene and 1-octene derived units. In yet another embodiment, the plastomer comprises ethylene derived units and from 10 wt % to 30 wt % of octene derived units. The plastomer may possess a melt index of from 0.1 to 20 dg/min, and from 0.1 to 10 dg/min in another embodiment.

In one embodiment, the plastomer is present in the composition from 2 to 20 phr, and from 10 to 15 phr in another embodiment.

In another aspect of the composition, the composition also comprises a processing oil. The oil is selected from parraffinic oils and polybutene processing oils, and mixtures thereof in one embodiment, and is a polybutene oil in another embodiment. The processing oil is present from 2 to 20 phr in one embodiment, and from 5 to 18 phr in another embodiment. Rosin oils may be present in compositions of the invention from 0.1 to 5 phr in one embodiment, and from 0.2 to 2 phr in another embodiment. Desirably, oils and processing aids comprising unsaturation comprise less than 2 phr of the compositions of the invention in one embodiment.

The composition may also include a filler selected from carbon black, modified carbon black, silicates, clay, exfoliated clay, and mixtures thereof.

In another embodiment, the composition also comprises a secondary rubber selected from natural rubbers, polyisoprene rubber, styrene-butadiene rubber (SBR), polybutadiene rubber, isoprene-butadiene rubber (IBR), styrene-isoprene-butadiene rubber (SIBR), ethylene-propylene rubber, ethylene-propylene-diene rubber (EPDM), polysulfide, nitrile rubber, propylene oxide polymers, poly(isobutylene-co-p-methylstyrene), halogenated poly(isobutylene-co-p-methylstyrene), poly(isobutylene-co-cyclopentadiene), halogenated poly(isobutylene-co-cyclopentadiene), and mixtures thereof. In another embodiment, the composition also comprises from 5 to 30 phr of a natural rubber.

The elastomer useful in the present invention comprises C₄ to C₇ isoolefin derived units. The C₄ to C₇ isoolefin derived units may be selected from isobutylene, isobutene, 2-methyl-1-butene, 3-methyl-1-butene, 2-methyl-2-butene, 1-butene, 2-butene, methyl vinyl ether, indene, vinyltrimethylsilane, hexene, and 4-methyl-1-pentene.

Further, the elastomer also comprises multiolefin derived units selected from isoprene, butadiene, 2,3-dimethyl-1,3-butadiene, myrcene, 6,6-dimethyl-fulvene, hexadiene, cyclopentadiene, and piperylene in another embodiment.

In yet another embodiment of a useful elastomer, the elastomer also comprises styrenic derived units selected from styrene, chlorostyrene, methoxystyrene, indene and indene derivatives, α-methylstyrene, o-methylstyrene, m-methylstyrene, and p-methylstyrene, and p-tert-butylstyrene.

The elastomer is halogenated in one embodiment.

The composition of the invention may also be cured using a curative. In one embodiment, the composition also comprises a curative selected from sulfur, sulfur-based compounds, metal oxides, metal oxide complexes, fatty acids, peroxides, diamines, and mixtures thereof.

The cured composition has desirable properties as an air barrier. For example, in one embodiment the composition has a brittleness value of less than −41.0° C. In another embodiment, the composition has a Shore A Hardness at 25° C. of less than 55. In yet another embodiment, the composition has an air permeability at 65° C. of less than 3.50×10⁻⁸ cm³-cm/cm²-sec-atm. And in yet another embodiment, the composition has an Adhesion to Carcass value of greater than 4 N/mm.

The composition can be used to make any number of articles. In one embodiment, the article is selected from tire curing bladders, innerliners, tire innertubes, and air sleeves. Other useful goods that can be made using compositions of the invention include hoses, seals, molded goods, cable housing, and other articles disclosed in THE VANDERBILT RUBBER HANDBOOK 637-772 (R.T. Vanderbilt Company, Inc. 1990).

Thus, the compositions of the present invention can be described alternately by any of the embodiments disclosed herein. For example, an aspect of the present invention may be described as a composition suitable for an air barrier comprising from 5 to 25 phr polybutene processing oil; halogenated star-branched butyl rubber; from 5 to 25 phr natural rubber; and from 5 to 25 phr of a plastomer, wherein the plastomer is a copolymer of ethylene derived units and C₃ to C₁₀ α-olefin derived units, the plastomer having a density of less than 0.915 g/cm³; and the composition having a Brittleness value of less than −41.0° C.

In another embodiment, the composition suitable for an air barrier consists essentially of an elastomer comprising C₄ to C₇ isoolefin derived units; and a plastomer, wherein the plastomer is a copolymer of ethylene derived units and C₃ to C₁₀ α-olefin derived units, the plastomer having a density of less than 0.915 g/cm³. In this embodiment, other minor components such as rosin oil, curatives and accelerators may also be present, individually, from 0.1 to 5 phr. And in yet another embodiment, the composition suitable for an air barrier consists essentially of an elastomer comprising C₄ to C₇ isoolefin derived units; and a plastomer, wherein the plastomer is a copolymer of ethylene derived units and C₃ to C₁₀ α-olefin derived units, the plastomer having a density of less than 0.915 g/cm³; and a polybutene processing oil. In this embodiment, other minor components such as rosin oil, curatives and accelerators may also be present, individually, from 0.1 to 5 phr.

### EXAMPLES

The present invention, while not meant to be limiting by, may be better understood by reference to the following example and Tables. The ingredients used are outlined in Table 3, and the components of each example outlined in Table 4, followed by data for each example in Tables 5 and 6.

Cure properties were measured using a ODR 2000 at the indicated temperature and 1.0 degree arc. Test specimens were cured at the indicated temperature, typically from 150° C. to 160° C., for a time (in minutes) corresponding to T90+ appropriate mold lag. When possible, standard ASTM tests were used to determine the cured compound physical properties. Stress/strain properties (tensile strength, elongation at break, modulus values, energy to break) were measured at room temperature using an Instron 4202 or Instron 4204. Shore A hardness was measured at room temperature by using a Zwick Duromatic.

Oxygen permeability was measured using a MOCON 0×Tran Model 2/61 operating under the principle of dynamic measurement of oxygen transport through a thin film as published by R. A. Pasternak et al. in 8 JOURNAL OF POLYMER SCIENCE: PART A-2 467 (1970). Generally, the method is as follows: flat film or rubber samples are clamped into diffusion cells which are purged of residual oxygen using an oxygen free carrier gas at 60° C. The carrier gas is routed to a sensor until a stable zero value is established. Pure oxygen or air is then introduced into the outside of the chamber of the diffusion cells. The oxygen diffusing through the film to the inside chamber is conveyed to a sensor which measures the oxygen diffusion rate.

Air permeability was tested by the following method. Thin, vulcanized test specimens from the sample compositions were mounted in diffusion cells and conditioned in an oil bath at 65° C. The time required for air to permeate through a given specimen is recorded to determine its air permeability. Test specimens were circular plates with 12.7-cm diameter and 0.38-mm thickness. The error (2σ) in measuring air permeability is ±0.245 (×10⁸) units.

The “adhesion to SBR” or “adhesion T-peel” test is based on ASTM D 413. This test is used to determine the adhesive bond strength between two rubber compounds, the same or different, after curing. Generally, the compounds used to make up the rubber (elastomeric) compositions are prepared on a three-roll mill to a thickness of 2.5 mm. An adhesive backing fabric is placed on the back of each compound. Typically, approximately 500 grams of stock blended elastomeric composition yields 16 samples which is enough for 8 adhesion tests in duplicate, wherein the calender is set to 2.5 mm guides spaced 11 cm apart.

The face of the two compounds are pressed and bonded to one another. A small Mylar tab is placed between the two layers of rubber compositions (SBR and test composition) on one end to prevent adhesion, and to allow approximately 2.5 inches (6.35 cm) of tab area. The samples are then cure bonded in a curing press at the specified conditions. One inch (2.54 cm)×6 inch (15.24 cm) specimens are die cut from each molded vulcanized piece. The tab of each specimen is held by a powered driven tensioning machine (Instron 4104, 4202, or 1101) and pulled at a 180° angle until separation between the two rubber compositions occurs. The force to obtain separation and observations on the torn specimens are reported.

Other test methods are summarized in Table 2. The error (2σ) in the later measurement is ±0.65 Mooney viscosity units. The average stress/strain value of at least three specimens is reported. The error (2σ) in tensile measurements is +0.47 MPa units. The error in the fatigue-to-failure values is ±20%. The error (2σ) in measuring 100% Modulus is ±0.11 MPa units; the error (2σ) in measuring elongation is +13% units.

A typical mixing procedure for components of the present invention is as follows: Brominated star-branched butyl rubber (SBB 6222, ExxonMobil Chemical Company, Houston Tex.), and natural rubber (NR, SMR 20), were first blended in a BR Banbury mixer at 40 rpm, 40 psi, TCU (temperature control unit) of 35° C. After 30 seconds, the carbon black was added, and after the temperature reached 100° C., the oils were added. The components were blended until the temperature reached 125° C. The blend was finalized on a two-roll mill in sheets by blending in the curatives: zinc oxide, stearic acid, MBTS accelerator, and sulfur.

Example 1 is a comparative example including 90 phr SBB and 10 phr of natural rubber (NR), using 4 phr of a rosin oil and 14 phr of a naphthenic oil (CALSOL). The comparative example was cured for 20 minutes at 150° C. using the same procedure and same curatives as the other examples 2 through 5. Examples 2 through 5 include the same amount of elastomer as in example 1, with varying amounts of the naphthenic oil and plastomer. Example 2 includes the plastomer and naphthenic oil. Examples 3 and 4 include the plastomer with a rosin oil alone, wherein naphthenic or aromatic oils have not been added; Example 5 includes the plastomer and polybutene processing oil with no added naphthenic or aromatic processing oils. The amounts (phr) of each component present in the examples is outlined in Table 4, and the cure properties of the comparative and other examples are in Table 5.

The examples were all tested for various physical properties, the results of which are outlined in Table 6. The data show that when the plastomer was present in the compositions, that the brittleness value improved when compared to example 1. Generally, cured compositions of the invention will have a brittleness value of from less than −41.0° C. in one embodiment, and less than −42.0° C. in another embodiment, and less than −43.0° C. in yet another embodiment, and less than −43.0° C. in yet another embodiment. Further, the air permeability improved (decreased) upon addition of the plastomer from 2 to 20 phr. Cured compositions of the invention will have an air permeability of from less than 4.0×10⁻⁸ cm³·cm/cm²·sec·atm in one embodiment, and less than 3.5×10⁻⁸ cm³·cm/cm²·sec·atm in another embodiment. This improved the most when a polybutene processing oil was also present, as in example 5. In that case, the cured compositions will have an air permeability of less than 3.5×10⁻⁸ cm³·cm/cm²·sec·atm in one embodiment, and less than 3.0×10⁻⁸ cm³·cm/cm²·sec·atm in another embodiment when polybutene processing oil is present from 5 to 25 phr. In one embodiment, the number average molecular weight range of the useful polybutene processing oil ranges from 500 to 2500.

The cure properties, such as Mooney scorch, T50, and T90 cure times are unchanged (within error) for the test compositions with and without plastomer and/or polybutene, as shown in Table 5. While the Shore A Hardness at 25° C. increased with addition of the plastomer (examples 2-4), this improved (decreased) upon addition of polybutene processing oil (example 5). A similar trend was also observed for the aged Shore A Hardness values. The Shore A Hardness at 25° C. of compositions of the invention are typically less than 55 in one embodiment, and less than 50 in another embodiment, and less than 47 in yet another embodiment of the invention. The aged Shore A Hardness values at 25° C. of the compositions of the invention are typically less than 60 in one embodiment, and less than 55 in another embodiment.

Further, the tensile strength values of compositions of the invention are improved when plastomer alone or with polybutene are present. The tensile strength of compositions of the invention are greater than 8.5 MPa in one embodiment, and greater than 9 MPa in another embodiment. Die B and Die C tear strengths are also improved when plastomer alone or with polybutene are present. Elongation at Break values remain unchanged (within error).

While the present invention has been described and illustrated by reference to particular embodiments, those of ordinary skill in the art will appreciate that the invention lends itself to many different variations not illustrated herein. For these reasons, then, reference should be made solely to the appended claims for purposes of determining the scope of the present invention. Further, certain features of the present invention are described in terms of a set of numerical upper limits and a set of numerical lower limits. It should be appreciated that ranges formed by any combination of these limits are within the scope of the invention unless otherwise indicated.

All priority documents are herein fully incorporated by reference for all jurisdictions in which such incorporation is permitted. Further, all documents cited herein, including testing procedures, are herein fully incorporated by reference for all jurisdictions in which such incorporation is permitted.

TABLE 2
Test Methods

| Parameter | Units | Test |
|---|---|---|
| Mooney Viscosity (BIMS polymer) | ML 1 + 8, 125° C., MU | ASTM D 1646 |
| | | (modified) |
| Mooney Viscosity (composition) | ML 1 + 4, 100° C., MU | ASTM D 1646 |
| Air permeability | cm³-cm/cm²-sec-atm | See text |
| Brittleness | ° C. | ASTM D 746 |
| Green Strength (100% Modulus) | PSI | ASTM D 412 |
| Mooney Viscosity (compound) | ML1 + 4, 100° C., MU | ASTM D 1646 |
| Mooney Scorch Time | Tₛ5, 125° C., minutes | ASTM D 1646 |
| Oscillating Disk Rheometer (ODR) | | |
| @ 160° C., ±3° arc | | |
| ML | deciNewton.meter | |
| MH | dNewton.m | |
| Tₛ2 | minute | |
| T_{c}90 | minute | |
| Cure rate | dN.m/minute | ASTM D 2084 |
| Physical Properties press cured Tc | | |
| 90 + 2 min @ 160° C. | | |
| Hardness | Shore A | ASTM D 2240 |
| Modulus 100% | MPa | ASTM D 412 Die B, C |
| Tensile Strength | MPa | |
| Elongation at Break | % | |
| Hot Air Aging, 72 hrs. @ 125° C. | | ASTM D 573 |
| Hardness Change | % | |
| Tensile Change | % | |
| Elongation Change | % | |
| Weight Change | % | |
| Tear Strength | N/mm | ASTM D 624 |
| Die B & Die C | | |
| Fatigue-to-Failure | cycles | ASTM 4482 using |
| | | Cam 24 (136% |
| | | extension) |

TABLE 3
Components and Commercial Sources

| Component | Brief Description | Commercial Source |
|---|---|---|
| CALSOL ™ 810 | Naphthenic Oil | R. E. Carroll, Inc |
| | ASTM Type 103 | (Trenton, NJ) |
| EXACT 8201 | 0.822 g/cm³; 1.1 dg/min | ExxonMobil Chemical |
| | C₂/C₈ α-olefin | Company (Houston, TX) |
| | copolymer | |
| KADOX ™ 911, | High Purity French | Zinc Corp. of America |
| zinc oxide | Process Zinc Oxide | (Monaca, Pa) |
| PARAPOL ™ | C₄ α-olefin polymer | ExxonMobil Chemical |
| | | Company (Houston, TX) |
| Rosin Oil | tackifier, including | Sovereign Chemical |
| MR-1085 A | unsaturated cyclic | (Akron, OH) |
| | carboxylic acids | |
| SBB 6222 | halogenated star- | ExxonMobil Chemical |
| | branched butyl rubber, | Company (Houston, TX) |
| | 2.4 wt % Br. | |
| stearic acid | Cure agent | e.g., C. K. Witco Corp. |
| | | (Taft, LA) |
| sulfur | cure agent | e.g., R. E. Carroll |
| | | (Trenton, NJ) |
| MBTS | 2-mercaptobenzothiazole | R. T. Vanderbilt |
| | disulfide | (Norwalk, CT) or |
| | | Elastochem (Chardon, |
| | | OH) |

TABLE 4
Components in Examples 1 through 5

| Component (phr) | 1 | 2 | 3 | 4 | 5 |
|---|---|---|---|---|---|
| SBB 6222 | 90 | 90 | 90 | 90 | 90 |
| NR, SMR 20 | 10 | 10 | 10 | 10 | 10 |
| Carbon black, N660 | 60 | 60 | 60 | 60 | 60 |
| oil, CALSOL 810 | 14 | 7 | — | — | — |
| oil, rosin | 4 | 4 | 4 | 4 | 4 |
| stearic acid | 1 | 1 | 1 | 1 | 1 |
| EXACT 8201 | — | 7 | 10 | 14 | 7 |
| PARAPOL 1300 | — | — | — | — | 7 |
| ZnO, KADOX 911 | 3 | 3 | 3 | 3 | 3 |
| MBTS | 1.25 | 1.25 | 1.25 | 1.25 | 1.25 |
| sulfur | 0.10 | 0.10 | 0.10 | 0.10 | 0.10 |

TABLE 5
Cure Properties of Examples 1 through 5

| Cure Properties | 1 | 2 | 3 | 4 | 5 |
|---|---|---|---|---|---|
| Mooney Scorch, t5 @ 135° C., | 13.83 | 13.9 | 11.7 | 12.3 | 13.4 |
| minutes | | | | | |
| Mooney viscosity, ML(1 + 4) @ | 44.1 | 42.8 | 71.9 | 67.6 | 59.0 |
| 100° C. | | | | | |
| ODR 2000, 1° Arc @ 150° C. | | | | | |
| Green strength, 100% Modulus, MPa | 0.33 | 0.33 | 0.63 | 0.68 | 0.49 |
| Green strength, Time to decay 75% | 2.40 | 3.35 | 11.65 | 14.99 | 12.70 |
| MH − ML | 4.36 | 3.81 | 6.08 | 5.51 | 5.34 |
| MH | 8.50 | 7.78 | 13.45 | 12.34 | 11.40 |
| ML | 4.14 | 3.97 | 7.37 | 6.83 | 6.06 |
| TS2, min | 6.34 | 6.59 | 5.32 | 5.67 | 5.97 |
| T50, min | 6.52 | 6.47 | 6.07 | 6.29 | 6.53 |
| T90, min | 10.2 | 10.5 | 9.4 | 9.7 | 10.1 |

TABLE 6
Physical Properties of Cured Samples of Examples 1 through 5

| Property | 1 | 2 | 3 | 4 | 5 |
|---|---|---|---|---|---|
| Hardness, Shore A @ 25° C. | 40.3 | 42.3 | 54.7 | 55.1 | 46.5 |
| 100% Modulus, MPa | 0.91 | 0.97 | 1.70 | 1.84 | 1.30 |
| 300% Modulus, MPa | 2.65 | 2.81 | 4.93 | 5.04 | 3.74 |
| Tensile, MPa | 6.94 | 6.72 | 9.48 | 9.68 | 8.85 |
| Elongation at Break, % | 751 | 727 | 670 | 693 | 742 |
| Aged Hardness, Shore A @ 25° C. | 52.9 | 55.5 | 58.5 | 59.7 | 52.3 |
| Aged 100% Modulus, MPa | 2.16 | 2.38 | 2.49 | 2.76 | 2.06 |
| Aged 300% Modulus, MPa | 6.56 | 6.64 | 7.52 | 7.75 | 6.55 |
| Aged tensile, MPa | 10.09 | 9.32 | 10.71 | 10.91 | 10.10 |
| Aged elongation, % | 547 | 526 | 553 | 546 | 554 |
| Die B tear, N/mm | 46.89 | 42.26 | 59.96 | 60.45 | 55.84 |
| Aged die B tear (120 hrs @ 100° C.), N/mm | 66.25 | 63.96 | 68.99 | 68.70 | 64.14 |
| Die C tear, N/mm | 24.82 | 25.42 | 35.25 | 34.76 | 32.73 |
| Aged die C tear (120 hrs @ 100° C.), N/mm | 36.23 | 35.74 | 36.68 | 36.82 | 37.51 |
| fatigue-to-failure, kcycles | 3139 | 2050 | 2910 | 2910 | 2050 |
| Aged fatigue-to-failure (120 hrs @ 100° C.), kcycles | 948 | 1475 | 790 | 477 | 1610 |
| Adhesion to carcass, N/mm | 6.13 | 6.38 | 3.73 | 3.73 | 5.73 |
| Aged adhesion to self (120 hrs @ 100° C.), N/mm | 8.67 | 5.79 | 5.08 | 5.69 | 4.62 |
| Aged adhesion to carcass (120 hrs @ 100° C.), N/mm | 2.67 | 1.07 | 0.75 | 1.07 | 1.30 |
| Air permeability, cm³-cm/cm²-sec-atm (×10⁸) | 4.53 | 3.49 | 3.64 | 3.75 | 2.45 |
| Brittleness, ° C. | −41.4 | −43.6 | −43.0 | −44.8 | −42.6 |

1. A composition suitable for an air barrier comprising an elastomer comprising C₄ to C₇ isoolefin derived units; and a plastomer, wherein the plastomer is a copolymer of ethylene derived units and C₃ to C₁₀ α-olefin derived units, the plastomer having a density of less than 0.915 g/cm³; wherein naphthenic and aromatic oils are substantially absent from the composition.

2. The composition of claim 1, wherein the plastomer comprises ethylene derived units and from 10 wt % to 30 wt % of C₃ to C₁₀ α-olefin derived units.

3. The composition of claim 1, wherein the plastomer comprises ethylene derived units and from 10 wt % to 30 wt % of units selected from 1-butene, 1-hexene and 1-octene derived units.

4. The composition of claim 1, wherein the plastomer comprises ethylene derived units and from 10 wt % to 30 wt % of octene derived units.

5. The composition of claim 1, wherein the plastomer has a melt index of from 0.1 to 10 dg/min.

6. The composition of claim 1, wherein the plastomer is present in the composition from 2 to 20 phr.

7. The composition of claim 1, wherein the plastomer is present in the composition from 10 to 15 phr.

8. The composition of claim 1, wherein the composition also comprises a processing oil.

9. The composition of claim 8, wherein the processing oil is selected from parraffinic oils and polybutene processing oils, and mixtures thereof.

10. The composition of claim 8, wherein the processing oil is present from 2 to 20 phr.

11. The composition of claim 1, also comprising a filler selected from carbon black, modified carbon black, silicates, clay, exfoliated clay, and mixtures thereof.

12. The composition of claim 1, the composition also comprising a secondary rubber selected from natural rubbers, polyisoprene rubber, styrene-butadiene rubber (SBR), polybutadiene rubber, isoprene-butadiene rubber (IBR), styrene-isoprene-butadiene rubber (SIBR), ethylene-propylene rubber, ethylene-propylene-diene rubber (EPDM), polysulfide, nitrile rubber, propylene oxide polymers, poly(isobutylene-co-p-methylstyrene), halogenated poly(isobutylene-co-p-methylstyrene), poly(isobutylene-co-cyclopentadiene), halogenated poly(isobutylene-co-cyclopentadiene), and mixtures thereof.

13. The composition of claim 12, wherein the secondary rubber is present from 5 to 30 phr.

14. The composition of claim 1, wherein the C₄ to C₇ isoolefin derived units are selected from isobutylene, isobutene, 2-methyl-1-butene, 3-methyl-1-butene, 2-methyl-2-butene, 1-butene, 2-butene, methyl vinyl ether, indene, vinyltrimethylsilane, hexene, and 4-methyl-1-pentene.

15. The composition of claim 1, wherein the elastomer also comprises multiolefin derived units selected from isoprene, butadiene, 2,3-dimethyl-1,3-butadiene, myrcene, 6,6-dimethyl-fulvene, hexadiene, cyclopentadiene, and piperylene.

16. The composition of claim 1, wherein the elastomer also comprises styrenic derived units selected from styrene, chlorostyrene, methoxystyrene, indene and indene derivatives, α-methylstyrene, o-methylstyrene, m-methylstyrene, and p-methylstyrene, and p-tert-butylstyrene.

17. The composition of claim 1, wherein the elastomer is halogenated.

18. The composition of claim 1, also comprising a curative selected from sulfur, sulfur-based compounds, metal oxides, metal oxide complexes, fatty acids, peroxides, diamines, and mixtures thereof.

19. The composition of claim 1, wherein the composition has a brittleness value of less than −41.0° C.

20. The composition of claim 1, wherein the composition has a Shore A Hardness at 25° C. is less than 55.

21. The composition of claim 1, wherein the composition has an air permeability at 65° C. is less than 3.50×10⁻⁸ cm³-cm/cm²-sec-atm.

22. The composition of claim 1, wherein the composition has an Adhesion to Carcass value is greater than 4 N/mm.

23. An article selected from tire curing bladders, innerliners, tire innertubes, and air sleeves made from the composition of claim 1.

24. A composition suitable for an air barrier comprising polybutene processing oil; an elastomer comprising C₄ to C₇ isoolefin derived units; and a plastomer, wherein the plastomer is a copolymer of ethylene derived units and C₃ to C₁₀ α-olefin derived units, the plastomer having a density of less than 0.915 g/cm³.

25. The composition of claim 24, wherein the plastomer comprises ethylene derived units and from 10 wt % to 30 wt % of C₃ to C₁₀ α-olefin derived units.

26. The composition of claim 24, wherein the plastomer comprises ethylene derived units and from 10 wt % to 30 wt % of units selected from 1-butene, 1-hexene and 1-octene derived units.

27. The composition of claim 24, wherein the plastomer comprises ethylene derived units and from 10 wt % to 30 wt % of octene derived units.

28. The composition of claim 24, wherein the plastomer has a melt index of from 0.1 to 10 dg/min.

29. The composition of claim 24, wherein the plastomer is present in the composition from 2 to 20 phr.

30. The composition of claim 24, wherein the plastomer is present in the composition from 3 to 10 phr.

31. The composition of claim 24, wherein the polybutene processing oil has a number average molecular weight of from 900 to 8000.

32. The composition of claim 24, wherein the polybutene processing oil is present from 2 to 20 phr.

33. The composition of claim 24, also comprising a filler selected from carbon black, modified carbon black, silicates, clay, exfoliated clay, and mixtures thereof.

34. The composition of claim 24, wherein paraffinic, naphthenic and aromatic oils are substantially absent from the composition.

35. The composition of claim 24, the composition also comprising a secondary rubber selected from natural rubbers, polyisoprene rubber, styrene-butadiene rubber (SBR), polybutadiene rubber, isoprene-butadiene rubber (IBR), styrene-isoprene-butadiene rubber (SIBR), ethylene-propylene rubber, ethylene-propylene-diene rubber (EPDM), polysulfide, nitrile rubber, propylene oxide polymers, poly(isobutylene-co-p-methylslyrene), halogenated poly(isobutylene-co-p-methylstyrene), poly(isobutylene-co-cyclopentadiene), halogenated poly(isobutylene-co-cyclopentadiene), and mixtures thereof.

36. The composition of claim 35, wherein the secondary rubber is present from 5 to 50 phr.

37. The composition of claim 24, wherein the C₄ to C₇ isoolefin derived units are selected from isobutylene, isobutene, 2-methyl-1-butene, 3-methyl-1-butene, 2-methyl-2-butene, 1-butene, 2-butene, methyl vinyl ether, indene, vinyltrimethylsilane, hexene, and 4-methyl-1-pentene.

38. The composition of claim 24, wherein the elastomer also comprises multiolefin derived units selected from isoprene, butadiene, 2,3-dimethyl-1,3-butadiene, myrcene, 6,6-dimethyl-fulvene, hexadiene, cyclopentadiene, and piperylene.

39. The composition of claim 24, wherein the elastomer also comprises styrenic derived units selected from styrene, chlorostyrene, methoxystyrene, indene and indene derivatives, α-methylstyrene, o-methylstyrene, m-methylstyrene, and p-methylstyrene, and p-tert-butylstyrene.

40. The composition of claim 24, wherein the elastomer is halogenated.

41. The composition of claim 24, also comprising a curative selected from sulfur, sulfur-based compounds, metal oxides, metal oxide complexes, fatty acids, peroxides, diamines, and mixtures thereof.

42. The composition of claim 24, wherein the composition has a brittleness value of less than −41.0° C.

43. The composition of claim 24, wherein the composition has a Shore A Hardness at 25° C. is less than 50.

44. The composition of claim 24, wherein the composition has a aged Shore A Hardness at 25° C. is less than 55.

45. The composition of claim 24, wherein the composition has an air permeability at 65° C. is less than 3.50×10⁻⁸ cm³-cm/cm²-sec-atm.

46. The composition of claim 24, wherein the composition has an Adhesion to Carcass value is greater than 4 N/mm.

47. An article selected from tire curing bladders, innerliners, tire innertubes, and air sleeves made from the composition of claim 24.

48. A composition suitable for an air barrier comprising from 5 to 25 phr polybutene processing oil; halogenated star-branched butyl rubber; from 5 to 25 phr natural rubber; and from 5 to 25 phr of a plastomer, wherein the plastomer is a copolymer of ethylene derived units and C₃ to C₁₀ α-olefin derived units, the plastomer having a density of less than 0.915 g/cm³; the composition having a Brittleness value of less than −41.0° C.

49. The composition of claim 48, wherein the polybutene processing oil has a number average molecular weight of from 900 to 3000.

50. An article selected from tire curing bladders, innerliners, tire innertubes, and air sleeves made from the composition of claim 48.
